(19) United States
(12) Patent Application Publication
(10) Pub. No.: US 2025/0245988 A1
(43) Pub. Date: Jul. 31, 2025

(54) Smart Refrigerator that uses Parallel Sensor Reading

(71) Applicant: Shadeeb Hossain, Brooklyn, NY (US)

(72) Inventor: Shadeeb Hossain, Brooklyn, NY (US)

(73) Assignee: Shadeeb Hossain, Brooklyn, NY (US)

(21) Appl. No.: 18/422,171

(22) Filed: Jan. 25, 2024

(51) Int. Cl. G06V 20/50; F25D 29/00; G06K 7/10; G06Q 10/087; G06Q 30/0601; G06V 10/75; G06V 10/82; G06V 20/68; H04N 23/90

(52) U.S. Cl. CPC G06V 20/50; F25D 29/00; G06K 7/10366; G06Q 10/087; G06Q 30/0637; G06V 10/75; G06V 10/82; G06V 20/68; F25D 2500/06; F25D 2700/06; F25D 2700/08; H04N 23/90

(57) ABSTRACT

Smart refrigerators connected to Internet of Things (IoT) will include a built-in system that would allow to effectively monitor when a food item is below the usual threshold and warn the user when a food item reaches close to expiration. A combination of hardware and software modules can be used to monitor periodically the status of the food items with no human intervention required. The system is reliable as it uses “parallel sensor readings” and artificial intelligence to make conclusive decisions. Ultrasonic transducers, cameras compatible with microcontroller, RFID scanners, monitor screen attached directly to the smart refrigerator—are all included in the front-end layer and are used individually and in compliment with each other to make decisions. The cloud server includes the database on product expiration, perishable food's shelf life, date of purchase, minimum threshold of required food items.

### BACKGROUND OF THE INVENTION

The invention is in the field of smart refrigerator connected with Internet of Things (IoT) with particular focus on an efficient food management. The concept of “parallel sensor” reading for the smart refrigerator using IoT involves the application of more than a single sensor's data for a more accurate interpretation. This will reduce the margin of error due to data derived from a single sensor.

The invention will have a self-operating system that will be able to track if a particular food item is running low in stock and consequently trigger a purchase request if approved by the user. The application will utilize “parallel sensor” reading methodology for a more accurate prediction. The first process involves multiple cameras interfaced with microcontroller for accumulation of the images. The identification of those food articles will be performed using supervised convolution neural network (CNN). The second process involves ultrasonic transducers to identify shelves that require re-stocking. A comparison with the previous day's data will reaffirm if a food article requires to be restocked if they are below a set threshold.

Consequently, the invention will also track inventories in the smart refrigerator and warn the user when they are close to expiration. RFID (radio frequency identifier) tags are conventional methods for tracking food items as they are stocked in the refrigerator and monitoring their expiration. The process can be complemented with image analysis to identify the food article and comparing them with a database for acceptable refrigeration shelf life. Perishable food items such as vegetables can be constantly monitored for their typical refrigeration shelf life. The “parallel sensor” reading will ensure that the relevant data are more accurately interpreted and would reduce the human intervention.

According to the data from Food and Agriculture Organization (FAO) of the United Nations approximately 40% of the food wastage occurs at the consumer level. A significant portion of this can be reduced if the user or consumer can be notified by a smart system that certain food items in their refrigerator are close to expiration. Tracking food items can also assist in reducing the number of trips required to the grocery store and thereby manage the carbon footprint accordingly. The invention builds on improving the standard of living of everyday consumers and simultaneously aids in food management through inventory tracking

### SUMMARY OF THE INVENTION

Smart refrigerators connected to an Internet of Things (IoT) platform have the advantage of efficient food management with minimum or no human intervention. A built-in system which includes a combination of hardware and software modules can monitor the status of your food items and send a signal if: (i) you are running low on a particular food item and (ii) your product has reached its expiration date. Both practices can reduce the food wastage occurring in our everyday lives. This technology can also be adapted both in a domestic and commercial setting to monitor food items in their stocks and thereby save time in inventory management and ensure that products close to expiration are taken care of as soon as possible. The signals can be in the form of text notification and through a monitor screen attached directly to the refrigerator.

The proposed design can be integrated into any refrigerator unit and is cost effective due to its low cost associated with the sensors and microcontroller. The individual sensors and microcontroller can also be easily replaced if needed. The technology also uses “parallel reading” from multiple sensors and uses artificial intelligence for a more accurate prediction.

The first objective of the proposed smart refrigerator connected to an IoT platform is an intelligent system that can scan through all the food items in your refrigerator. It can be done using multiple cameras and ultrasonic transducers strategically placed across the different edges of the shelves in the smart refrigerator unit. All the cameras and ultrasonic transducers are connected to the microcontroller. A python script is used to read and control the signals from the sensors which includes the multiple cameras and the ultrasonic transducers interfaced with the microcontroller. The purpose is to identify food items on the shelves and retrieve relevant information whether a particular shelf is empty.

The scanned image of each item on the shelf is analyzed to identify the corresponding food article. Each item in the scanned image can be identified using a python script written for convolution neural network. Supervised learning can be used for an accurate prediction of food articles. The next step is to compile a list of those articles which will be compared to the prior day's list of items. There is a pre-existing database with a list of food items and the minimum requirements of those items that need to be stocked. The quantity of the “missing” food items can be compared to the threshold set for the minimum quantity.

The ultrasonic transducer is used to determine whether a food item is placed on the shelves. This will help to identify whether the fridge is almost empty and therefore needs restocking. It uses the principle of distance=speed*(time/2). The time taken to send and receive the ultrasonic waves is used to measure the distance. The length and width of the shelves are already known and hence a simple python algorithm can be used to determine if a food item is already on the shelf or whether it needs to be restocked. This application is beneficial particularly in commercial smart refrigerators where each item is stocked in their assigned shelf.

The “parallel reading” from both the cameras and ultrasonic transducers will ensure that an accurate list of items that need to be restocked is compiled. This will reduce our margin of error in accurate prediction. A notification can be sent to the user if they want to make a purchase of food items that are below the set threshold. If the user agrees on the purchase, the system can be connected to a third-party purchasing site using an Application Programming Interface (API). If the user disagrees with the purchase, no further action needs to be taken.

The second objective of the smart IoT connected refrigerator is monitoring the status of the food items from the date of purchase. This can be done both via radio frequency identifier (RFID), image analysis or the user via manually selecting the food items through a touch screen attached to the refrigerator unit. The goal is to identify food items that are close to expiration.

The Radio frequency identifier (RFID) reader is interfaced with the microcontroller and attached at the door of the refrigerator unit. The data is exchanged through the serial peripheral interface (SPI) protocol. The proposed frequency of communication is at 13.56 MHz as it is the frequency used by the microcontroller to communicate with the RFID tags. When a consumer is restocking their refrigerator, the user will have the flexibility to either use the RFID reader to scan the product. A secondary option of manually selecting the list of items will also be available. This involves a touch screen mounted on the refrigerator door which can be used to input the “new” items.

Additionally, the cameras will be able to scan and identify the food items that are recently stocked. This can be done by taking a snapshot of newly placed food items on the shelf and sending them directly to the cloud server. Convolution neural network will be able to identify the food items and link them to the database will includes a proposed refrigeration shelf life which is applicable for perishable food items.

The use of RFID tags and cameras are another example of the “parallel reading” of the sensors and will be able to effectively identify the food items. The option of the manual input by a touch screen tablet or monitor attached to the refrigeration unit will ensure that all necessary measurements are taken care of for a better user experience.

The stocked food items can be compared to the expiration dates and for perishable food items such as fruits and vegetables they can be compared to a database which has a list compiled for maximum days for refrigeration. A notification will be sent to the user two days prior to expiration and asked if they are interested in making a purchase. Additional notification can be sent on the day of the expiration to discard the expired food item. The notification can be in the form of text and additional reminders will be made on the attached touch screen on the refrigerator unit.

The invention is a cloud based multi-layered architectural framework. The front-end layer, gateway layer and the backend layer. The front-end layer will focus on the hardware components discussed earlier and will be responsible for primarily collecting the data from the sensors and execution. These devices communicate directly or indirectly with the internet. The sensors, interfacing circuits and microcontroller are all part of the front-end layer.

The gateway layer is used to communicate between the front-end layer and the back-end layer. For the data exchange protocols in IoT gateway, the data centric architecture Data Distribution service (DDS) is used.

The cloud server is synonymous with the back-end layer. It is responsible for accepting the data from the IoT gateway layer and communicating with the internet enabled devices. The data from the: camera module, ultrasonic transducer, RFID reader and the touch screen monitor (mounted on the refrigerator unit) is analyzed in the back-end layer. A python script will be used to generate the response signal. The actuated signal is then relayed through the gateway layer to the corresponding front end layer.

### BRIEF DESCRIPTION OF DRAWINGS

In the following detailed portion of the present description, the teachings of the present application will be explained in more detail with reference to the example embodiments shown in the drawings, in which:

FIG. 1 shows the detailed process associated with identifying when a particular food item is running low in the refrigerator stock using “parallel reading” of sensors and convolution neural network.

FIG. 2 is associated with the placement of multiple ultrasonic transducers across the different shelves on the refrigerator.

FIG. 3 shows the microcontroller and the ultrasonic transducer and the camera that will be used for the process described in FIG. 1

FIG. 4 shows the schematic on how the ultrasonic transducer can be used to determine if a shelf is stocked using the echo process of ultrasonic waves.

FIG. 5 shows the template of the database that will include the name of the food article and the corresponding threshold or minimum quantity that needs to be always stocked.

FIG. 6 shows a notification template sent to a user inquiring if they are interested in a purchase.

FIG. 7 shows the placement of the multiple cameras across the different positions of the refrigerator unit to ensure it is effectively capturing the images of each item on the shelves.

FIG. 8 shows the detailed process associated with monitoring the expiration date of the inventory in the refrigerator unit using “parallel reading” of sensors and convolution neural network.

FIG. 9 shows the placement of the radiofrequency identifier (RFID) reader placed near the doorframe of the refrigerator unit.

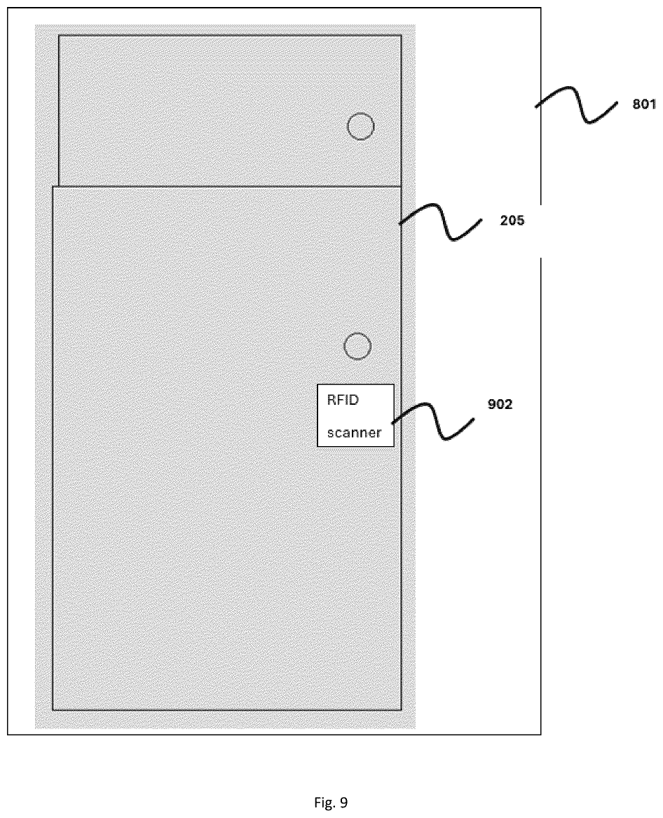

FIG. 10 shows the template of a database that can be used to compare the food items in the refrigerator unit with their date of purchase and date of expiration.

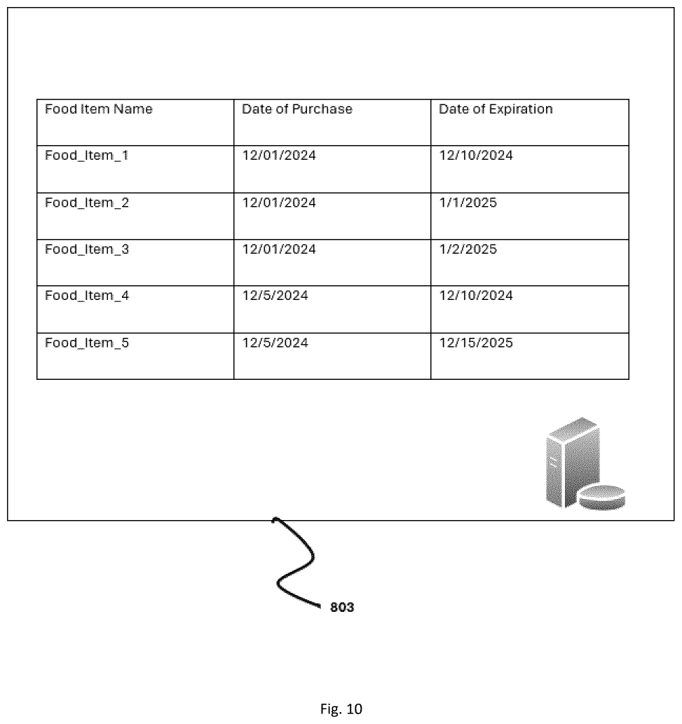

FIG. 11 shows the notification template inquiring if the user wants to make a purchase of the article that is close to expiration. This notification is intended to be sent two days prior to expiration date.

FIG. 12 shows the notification template on the touch screen monitor or tabloid mounted on the refrigerator door. The template includes a final reminder that the product needs to be discarded after it reaches its expiration date.

FIG. 13 shows the notification template with a final reminder that the product has expired and needs to be discarded.

FIG. 14 shows the RFID scanner or reader that needs to be connected to a microcontroller to operate and execute the function of reading the product type and expiration date.

FIG. 15 shows the template of the touch screen monitor that can be used by the consumer to select the perishable food items as they are freshly stocked in the refrigerator. The template will include details about the refrigeration shelf life (the expiration date).

### DETAILED DESCRIPTION

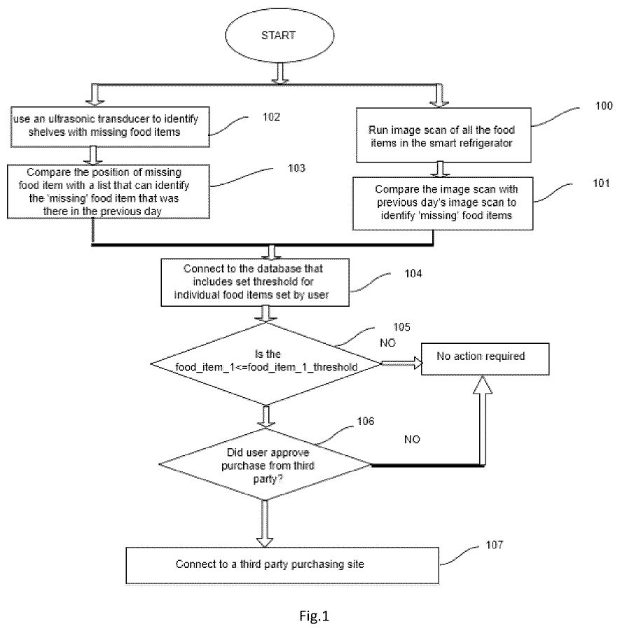

In the following detailed description, the invention according to the teachings for this application is in the form of a smart refrigerator connected to IoT with “parallel sensor” reading will be described in the embodiments. The detailed system to monitor the stock level of each food item in the refrigerator unit is discussed in detail as shown in FIG. 1.

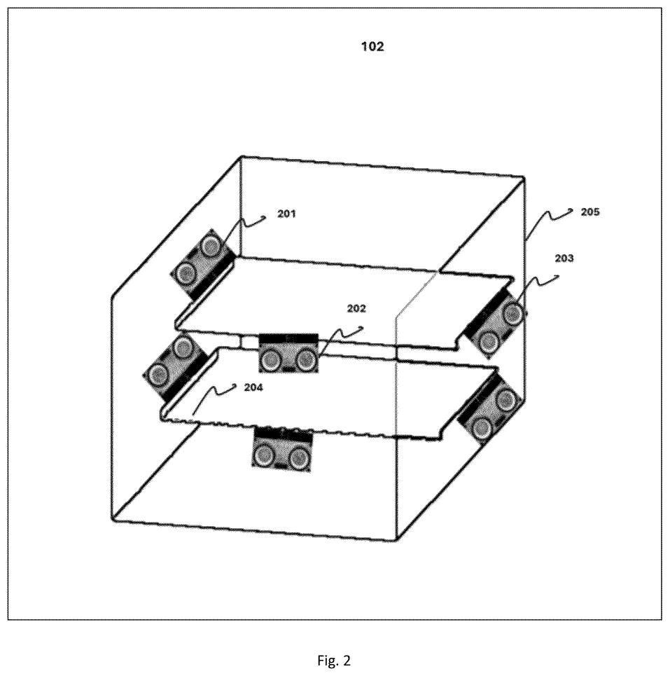

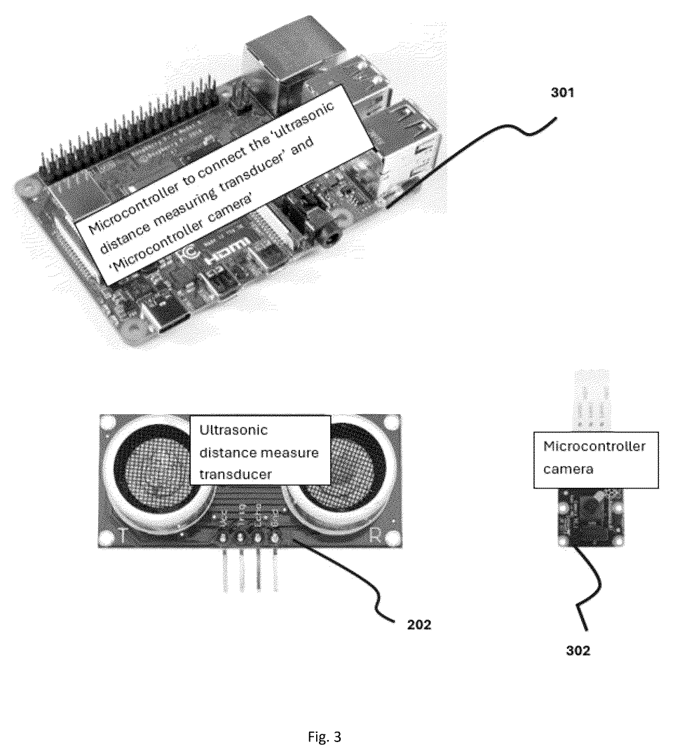

A first embodiment of the invention is the placement of ultrasonic transducers 201, 202 and 203 along the edges of each shelf 204 of the refrigerator unit 205 as shown in FIG. 2. Each of the ultrasonic transducers 201,202 and 203 are connected to the microcontroller 301 through the general-purpose input output (GPIO) pins as shown in FIG. 3. Cameras 302, 702 and 703 are similarly interfaced with the microcontroller 301 through the GPIO pins in 301.

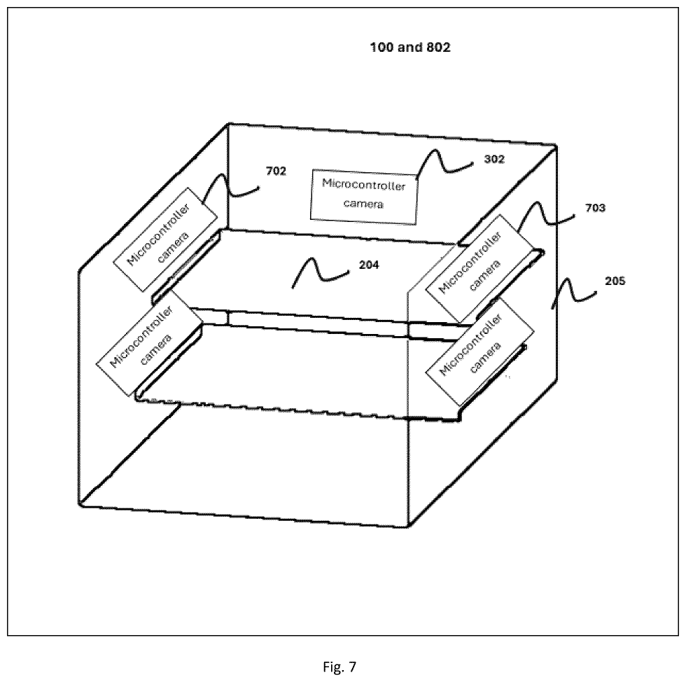

In the first step 101, as per FIG. 7, the cameras 302,702 and 703 placed along the multiple edges of the shelves 204 are used to take pictures in real time of all the food items. The graphics processing unit (GPU) firmware and all the necessary applications of the microcontroller 301 need to be up to date to operate. The cameras 302, 702 and 703 can be run by using a python code run on the microcontroller 301 operating system (OS). Each image scan across each shelf 204 needs to be labelled and saved.

The image is initially saved in the local file system. It will be uploaded to a remote server. The front-end layer is the hardware components that capture the images. The front-end layer includes the microcontroller 301, the individual cameras 302, 702 and 703, ultrasonic transducers 201, 202 and 203, and RFID scanner 902. The tablet 903 and cell phone 904 will be connected to the IoT platform.

The back-end layer is the cloud server. The gateway layer is used to communicate between the front-end layer and back-end layer using Data Distribution Service (DDS).

Python code will be used both on the client front end and the server. The server will support uploading of the new image and storing them on the file system. In the server, the new scanned image of each item on shelf 204 is analyzed to identify the corresponding food article. A pre-trained convolution neural network (CNN) using python code can be used to develop the algorithm for accurate identification of each food article.

In the next step 101, the new image scanned will be compared to the previous stored image taken a day prior. The list of the new items will be compared to the previous list of articles taken from the earlier day. A simple python code will be used to identify and complete the list of the “missing items”.

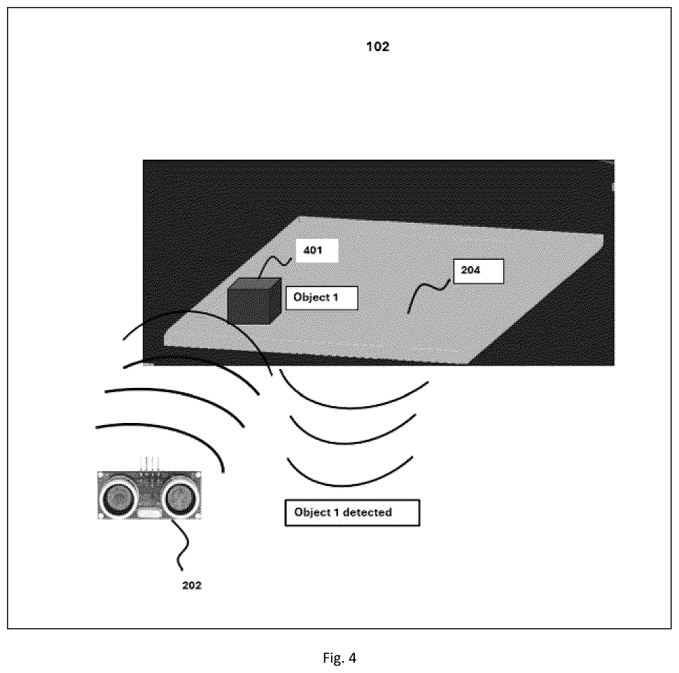

Simultaneously, as per step 102, the ultrasonic transducers 201,202 and 203 will be used to measure if shelf 204 is vacant. As an example, FIG. 4 the ultrasonic transducer 202 will send an ultra-sonic wave to object 401 placed on the shelf 204 and an equation is used to measure the time taken for the wave to reflect. The time taken to send and receive an ultrasonic signal will be used to measure the distance according to the equation: distance=speed*(time/2). The length and width of shelf 204 is known and hence a python algorithm will allow us to determine if object 401 is placed on shelf 204.

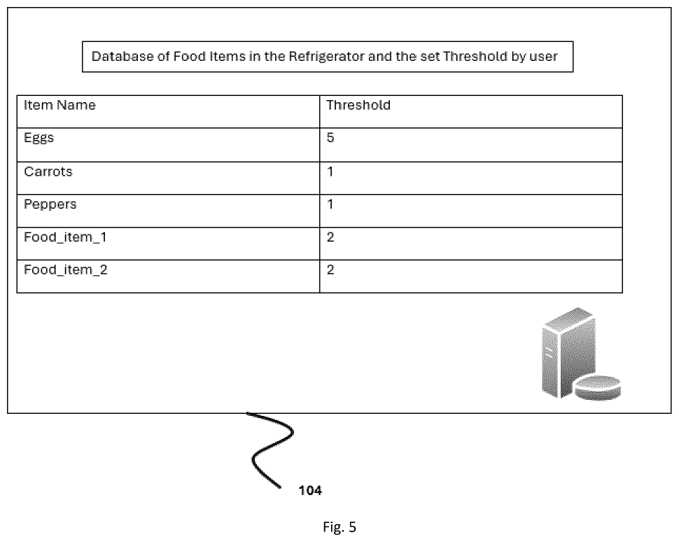

The output from 101 and 103 which is an example of “parallel reading” of sensors will be relayed from front end layer to cloud server using the gateway layer. FIG. 5, an SQL server, 104 will retain information about food items in the refrigerator 205 and the minimum requirements of each food item aka “threshold”. A decision process 105 will be made by comparison of the pre-existing food item's quantity against a set threshold food item's quantity.

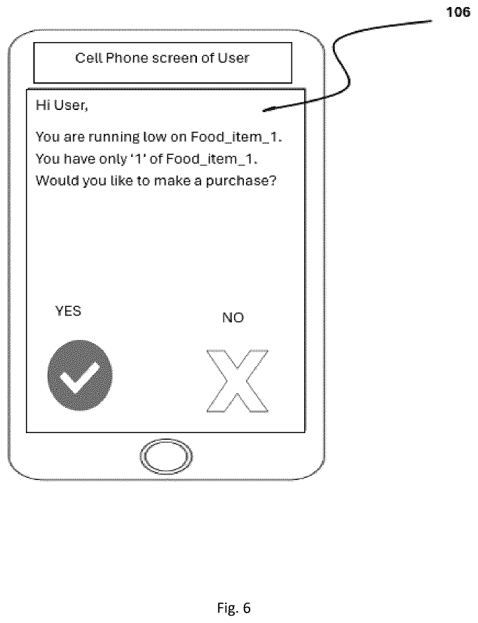

If the quantity is more or equal, then no action is required. However, if the quantity is below threshold 106 a message would be sent according to FIG. 6 inquiring if the consumer is interested in making a purchase. If the consumer agrees to purchase 107, they will be connected through an application processing interface (API) to a third-party online retail store where they can make the purchase. However, the consumer will also have an option to opt out of the purchase and no further action will be taken.

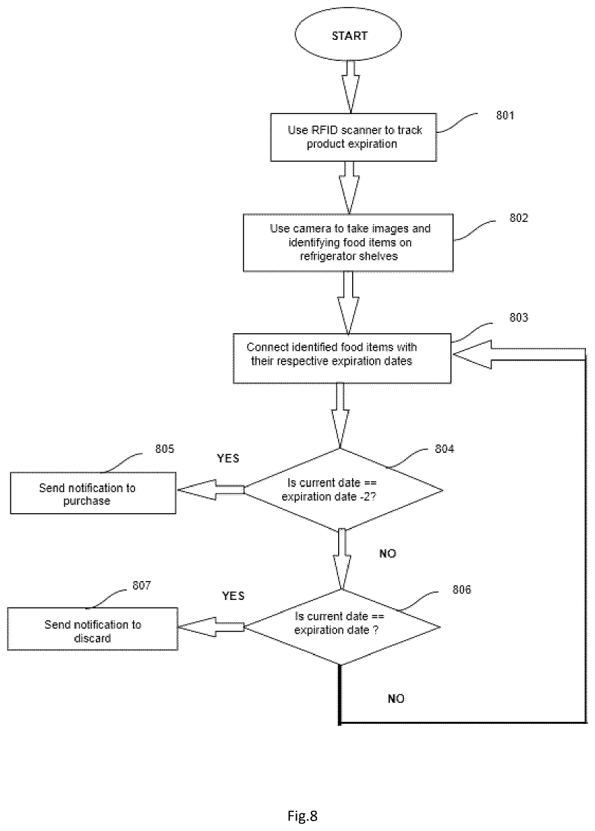

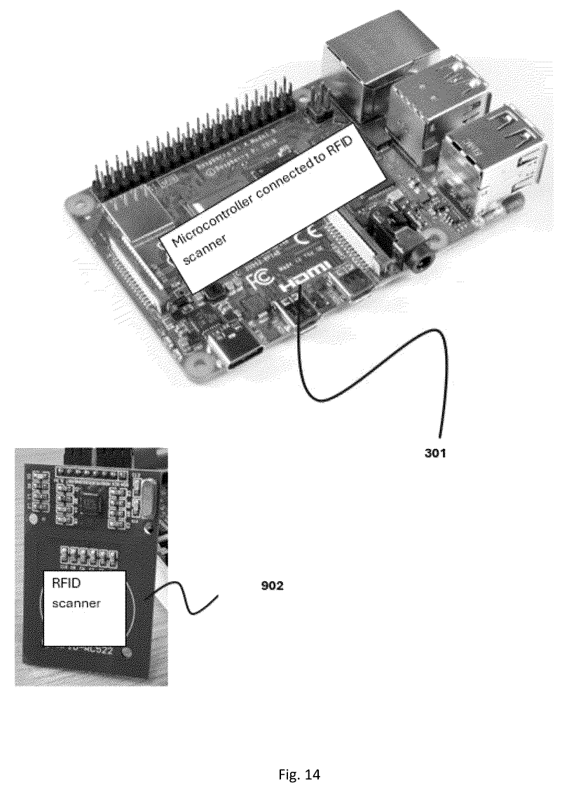

FIG. 8 shows the associated steps with monitoring the status of food items using a smart refrigerator connected to IoT 205 using “parallel sensor” reading. The first step 801 is the use of radio frequency identifier (RFID) scanner 902 that is attached to the door of smart refrigerator 205. The RFID 902 will be used to scan each of the food items that has an RFID tag as they are stocked into the refrigerator 205. The RFID reader or scanner 902 is also interfaced with microcontroller 301 as shown in FIG. 14.

The data exchange is through serial peripheral interface (SPI) protocol and the frequency of communication is proposed at 13.56 MHz which is typical for microcontroller 301 to communicate with RFID tags.

A secondary option, 802, can be used for the camera 302, 702 and 703 to take images of each food item as it stocked into the shelves 204. The images will be relayed to the cloud server using the gateway layer as discussed earlier. In the cloud server, a pretrained model for object identification, GoogleNet or a self-trained supervised CNN can be used to identify the food item. A list of the fresh stocked food articles will be saved in the cloud server.

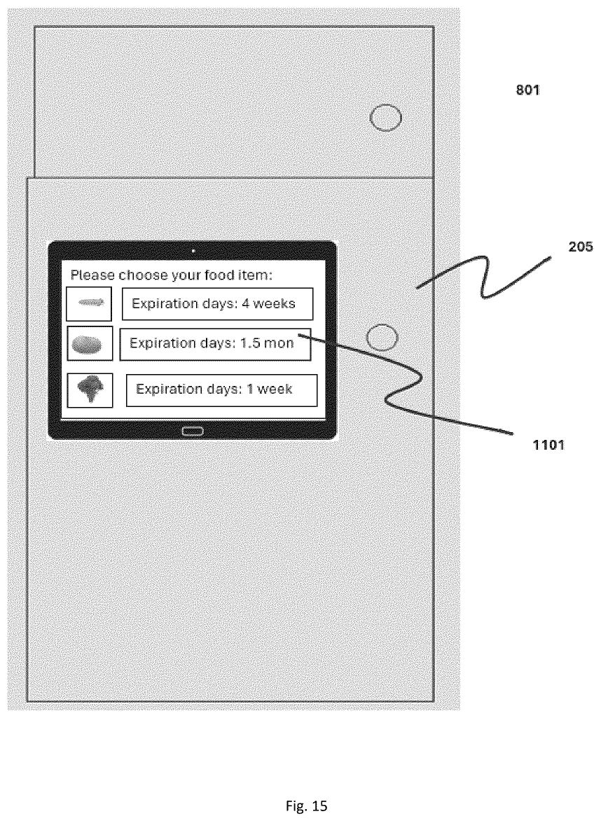

A tertiary option FIG. 15 is using touch screen tablet or monitor 903 mounted on the refrigerator 205 to select the perishable food items 1101. A list of the most frequently bought food items by the user will be available to select from the list. There will also be an option to input new food items. This option is available because occasionally GoogleNet and self-trained Neural Network cannot identify the food items accurately and hence FIG. 15 allows the user to select the food items in case a mistake occurs in identification of the food article by the CNN image analysis in the refrigerator 205.

This is another example of the “parallel readings” that will ensure that the food item that is stocked is identified correctly. This is primarily important because Artificial Intelligence (AI) is still a relatively developing field and can account for higher chances of inaccuracies. Therefore, two or three readings can ensure that correct predictions are made.

A list of identified food items compiled from 801 and 802 is relayed to the cloud server in 803 where the SQL server contains a list of food items and will track the date of purchase and date of expiration. Most of the food items will contain the expiration date received from the RFID tag 801. However, for perishable food items a database of selected food items with their tentative expiration date based on the refrigeration shelf life will be used to predict their corresponding expiration.

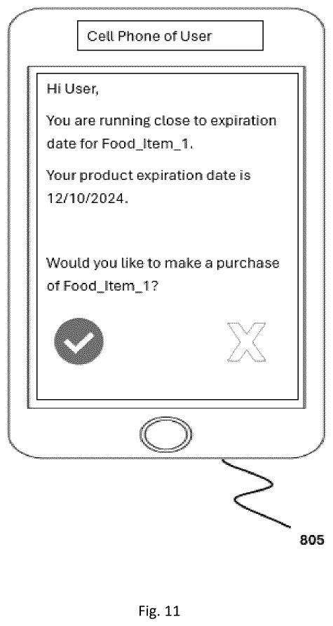

A python code can be used to scan everyday through the list of the food articles in the refrigerator 205 as part of the process in 101. The food articles are also compared with their refrigeration shelf life 804 every day. The food item(s) are identified with two days remaining prior to their expiration 804. If the current date==expiration date−2, a notification 805 can be sent to a cell phone 904 of the consumer alerting them that their product-X is close to expiration as shown in FIG. 11.

A notification will also be sent to 805 inquiring if they are interested in making a purchase of the close to expired product. If the consumer agrees to the purchase, they will be connected through an API to a third-party online retail store to make the purchase.

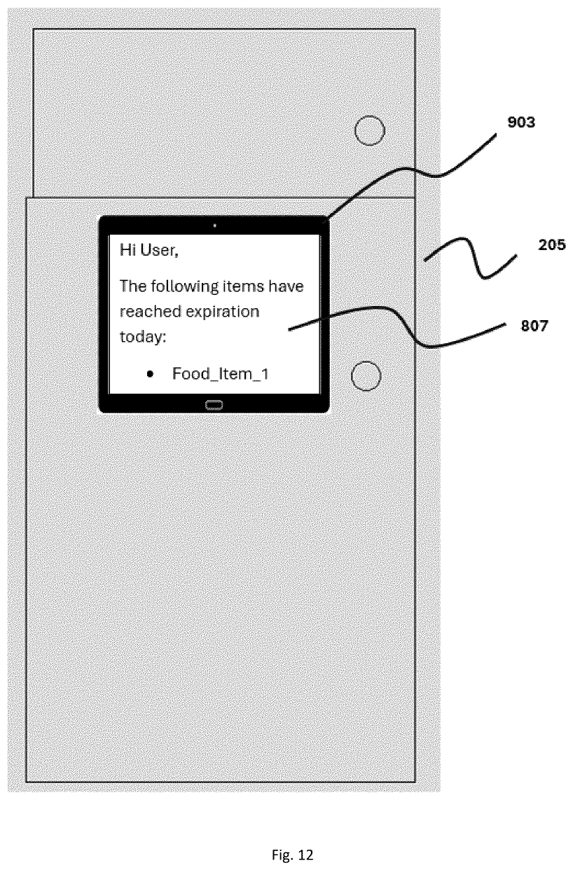

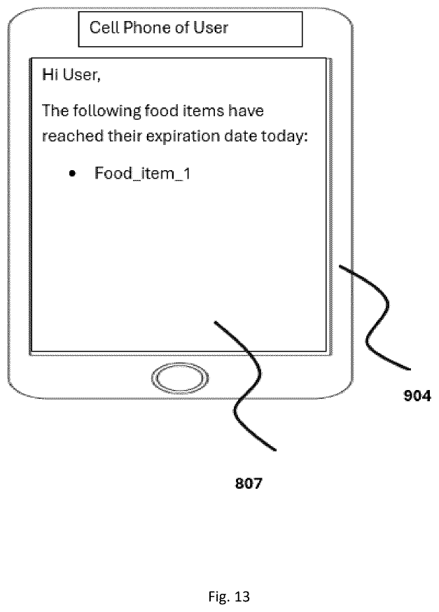

A final reminder 806 will be sent when the expiration date==current date. The notification will be sent both to the cell phone of the user 904 and the tablet 903 mounted on the refrigerator 205 as shown in FIGS. 12 and 13 respectively. Both steps would ensure that the expired food items are discarded on time.

The invention claimed is:

1. A smart refrigerator connected to an IoT will be able to monitor the status of all the food items in the unit using “parallel reading” of sensors and artificial intelligence and thereby send an appropriate signal to the user if (i) they are running low on a particular food item by comparing against a ‘threshold of quantity required’ in the refrigerator. The threshold is initially set by the user.

2. The smart refrigerator connected to an IoT will be able to notify the user (ii) when the product is close to expiration depending on their marked expiration date for ‘packed’ products and for perishable food items on comparison against their desired refrigeration shelf life.

3. The smart refrigerator connected to IoT in claim 1 will use the cameras positioned across the different edges on the shelves to snap a picture every day and use pre-trained convolution neural network model to identify the food items and compile a list of food items in the shelf.

4. The images compiled in claim 3 will be compared against the previous day's list to identify the “missing items”.

5. According to claim 1, ultrasonic transducers positioned across the different edges on the shelves will be used to identify vacant shelves and compare against the previous day's stock to identify the list of “missing items”.

6. According to claim 1, a SQL server will be used to identify the food items from claims 4 and 5 and compare them through a python script to learn if they are below the threshold.

7. According to claim 1 a notification will be sent to the consumer asking them if they want to make a purchase of the “missing items” that are below threshold as identified in claim 6.

8. According to claim 1, if the user approves a purchase, then an API (Application Packaging Interface) will be used to connect to a third-party online retail store to make the purchase.

9. The smart refrigerator connected to IoT according to claim 2 will use an RFID scanner to scan the RFID tags and record the food items as they are stocked into the smart refrigerator.

10. The smart refrigerator connected to IoT in claim 2 also uses cameras to take pictures of the fresh bought food articles as they are stocked into the shelves. Convolution Neural Network can be used to identify food articles.

11. The smart refrigerator in claim 2 will have an option to select the food items from a touch screen mounted and connected to the refrigerator. For perishable food items they will also include a tentative refrigeration shelf life.

12. According to claim 2, the list of food items will be regularly tracked until their expiration is two days prior to the current date. A SQL server database will be used on the cloud to track the food items, their date of purchase and their date of expiration.

13. According to claim 2, for perishable food items a tentative expiration date is presumed from the typical refrigeration shelf life. The database can be created using information available online.

14. According to claim 2, the list of food items that are close to expiration will be compiled. A text notification will be sent to the user to know whether the user wants to make a purchase. An API can be used as discussed in claim 8 to make the purchase from a third-party online retail store.

15. According to claim 2, the list of food items in claims 12 and 13 that have reached the exact day of expiration will be sent as a notification to the user to discard the food items. The notification will be in the form of text/SMS service and also simultaneously displayed on the touch screen tablet mounted on the smart refrigerator.
